(19) United States
(12) Patent Application Publication
(10) Pub. No.: US 2026/0362099 A1
(43) Pub. Date: Nov. 12, 2026

(54) METHODS, ARCHITECTURES, APPARATUSES AND SYSTEMS FOR COORDINATION AND COLLECTION OF NON-CELLULAR SENSING DATA FOR WIRELESS CELLULAR NETWORKS

(71) Applicant: InterDigital Patent Holdings, Inc., Wilmington, DE (US)

(72) Inventors: Laksh Bhatia, London (GB); Magurawalage Chathura Madhusanka Sarathchandra, London (GB); Sebastian Robitzsch, London (GB); Alain Mourad, Ascot (GB)

(21) Appl. No.: 19/202,987

(22) Filed: May 8, 2025

(51) Int. Cl. H04W 4/38; H04W 64/00; H04W 84/12

(52) U.S. Cl. CPC H04W 4/38; H04W 64/003; H04W 84/12

(57) ABSTRACT

The present disclosure is related to WTRU coordination and collection of Wi-Fi sensing data for wireless cellular networks. The WTRU may transmit first information for registering the WTRU. The WTRU may identify one or more Wi-Fi service set identifiers (SSIDs) accessible by the WTRU with sensing capabilities. The WTRU may transmit second information indicating the identified one or more SSIDs. The WTRU may receive a request to perform a sensing service task, wherein the request is based at least in part on the second information. The WTRU may perform the sensing service task based at least in part on the request, wherein performing the sensing service task comprises receiving from at least one of the identified one or more SSIDs first sensing data. The WTRU may transmit second sensing data, wherein the second sensing data is generated using data from the first sensing data.

### BACKGROUND

Integrated Sensing and Communication (ISAC) is one of the core features of future wireless communication networks. ISAC enhances the capabilities of telecommunication networks by sensing objects in a space with only RF-based signals. In theory, ISAC should work in a wide range of scenarios like indoors, outdoors, and while transitioning between them. However, there are several use-cases for enhancing wireless cellular network (e.g., 3^{rd} Generation Partnership Project (3GPP)) sensing with non-cellular (e.g., non-3GPP) sensing data (e.g., cameras, light detection and ranging (LiDAR), IMU, Wi-Fi, Bluetooth low energy (BLE), ultra-wideband (UWB), and radar). For example, non-cellular (e.g., non-3GPP) sensors may be additional sources of information, provide sensing information where wireless cellular network (e.g., 3GPP) sensing is unavailable, or provide supplementary sensing sources. The current wireless cellular network (e.g., 3GPP) system does not enable non-cellular (e.g., Wi-Fi) sensing capabilities to be used for augmenting sensing services provided by the wireless cellular network (e.g., 3GPP) system to applications or wireless cellular network system-internal components. It is not currently possible for the wireless cellular network system to discover available Wi-Fi sensing capabilities within an area of interest (e.g., sensing area, target sensing service area (TSSA), non-cellular tracking area). Moreover, there are no procedures today which enable non-cellular (e.g., Wi-Fi) sensing to be initiated or executed for obtaining non-cellular sensing data to be used within the wireless cellular network (e.g., 3GPP) system while ensuring performance requirements of the sensing tasks are met.

### SUMMARY

The present disclosure is generally directed to the fields of communications, software and encoding, including, for example, to methods, architectures, apparatuses, systems related to coordination and collection of non-cellular (e.g., Wi-Fi) sensing data for wireless networks (e.g., wireless cellular networks, 6G Core (6GC)). This disclosure may provide a method performed by a wireless transmit/receive unit (WTRU) and a WTRU device for coordinating and collecting non-cellular (e.g., Wi-Fi) sensing data for wireless networks (e.g., 6GC). In accordance with certain embodiments of the present disclosure, the WTRU transmits, to a wireless network, first information for registering the WTRU. The WTRU may identify one or more Wi-Fi service set identifiers (SSIDs) accessible by the WTRU with sensing capabilities based at least in part on the WTRU being registered with the wireless network. The WTRU may transmit, to the wireless network, second information indicating the identified one or more SSIDs. The WTRU may receive, from the wireless network, a request to perform a sensing service task, wherein the request is based at least in part on the second information. The WTRU may perform the sensing service task based at least in part on the request, wherein performing the sensing service task comprises receiving from at least one of the identified one or more SSIDs first sensing data. The WTRU may transmit, to the wireless network, second sensing data, wherein the second sensing data is generated using data from the first sensing data.

In some embodiments, the first information comprises any one or more of a list of Wi-Fi access points, a Wi-Fi station security parameter, a Wi-Fi station received signal strength indicator, a Wi-Fi station supported mode, or a relative distance of Wi-Fi access points.

In some embodiments, the second information comprises any one or more of a list of Wi-Fi access points, a Wi-Fi station security parameter, a Wi-Fi station received signal strength indicator, or a Wi-Fi station supported mode.

In some embodiments, the request to perform a sensing service task comprises any one or more of a sensing task ID, a consent token, a sensing object identifier, a reporting configuration, a data path, a time to perform the sensing service task, a sensing mode and its configurations, processing functions, or a reporting endpoint.

In some embodiments, the first sensing data comprises any one or more of a received sensing signal, sensing task ID, channel state information, a time of flight information, an accuracy of the sensing data, micro-doppler information, an object characteristic, a received signal strength, a relative real-time location of a Wi-Fi access point, a relative real-time location of a Wi-Fi station, or a confidence interval.

In some embodiments, receiving from the at least one of the identified one or more SSIDs the first sensing data is done at a first time, performing the sensing service task comprises receiving from the at least one of the identified one or more SSIDs third sensing data at a second time, and the second time is subsequent to the first time.

In some embodiments, the WTRU transmits, to the wireless network, fourth sensing data, wherein the fourth sensing data is generated based at least in part on the third sensing data, wherein a difference between the second time and the first time is greater than a predetermined threshold time difference.

In some embodiments, the fourth sensing data comprises a rejection message of the sensing service task, wherein the rejection message of the sensing service task comprises a list of rejection reasons.

In some embodiments, the request to perform the sensing service task is based on an identification of at least one key performance indicator (KPI) violation or on receiving a sensing service request.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative diagram of a Wi-Fi sensing scenario, according to some embodiments of this disclosure;

FIG. 3 is an illustrative flow diagram of steps for registering of sensing enabler client (SEC) to sensing enabler server (SES) and SES to sensing coordination function (SCF), according to some embodiments of this disclosure;

FIG. 4 is an illustrative flow diagram of steps for trigger and discovery scenarios for Wi-Fi sensing, according to some embodiments of this disclosure;

FIG. 5A is a first portion of an illustrative flow diagram of steps for wireless cellular network (e.g., 6GS) controlled Wi-Fi sensing, according to some embodiments of this disclosure;

FIG. 5B is a second portion of an illustrative flow diagram of steps for wireless cellular network (e.g., 6GS) controlled Wi-Fi sensing, according to some embodiments of this disclosure;

FIG. 6 is an illustrative flow diagram of steps for wireless cellular network (e.g., 6GS) controlled multi-WTRU discovery for Wi-Fi sensing, according to some embodiments of this disclosure; and

FIG. 7 is an illustrative flow diagram of steps for coordination and collection of Wi-Fi sensing data for wireless cellular networks (e.g., 6GC), according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

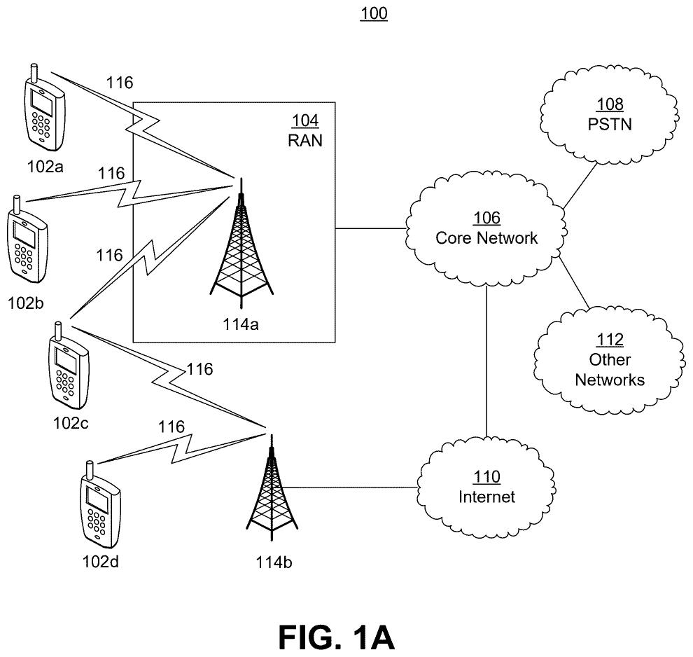

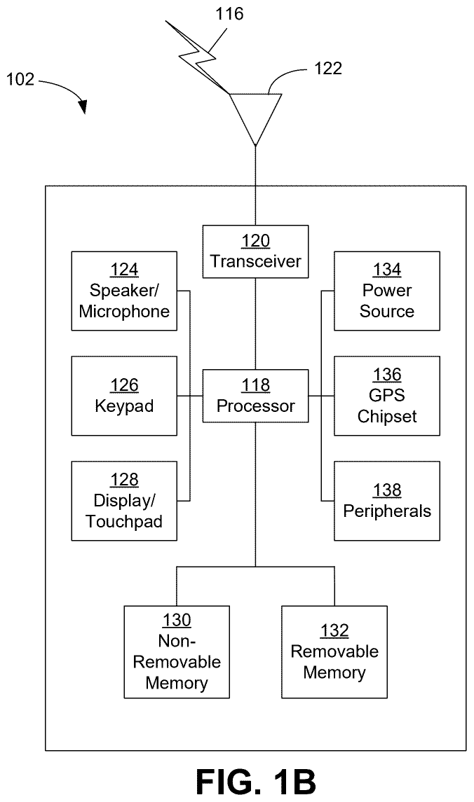

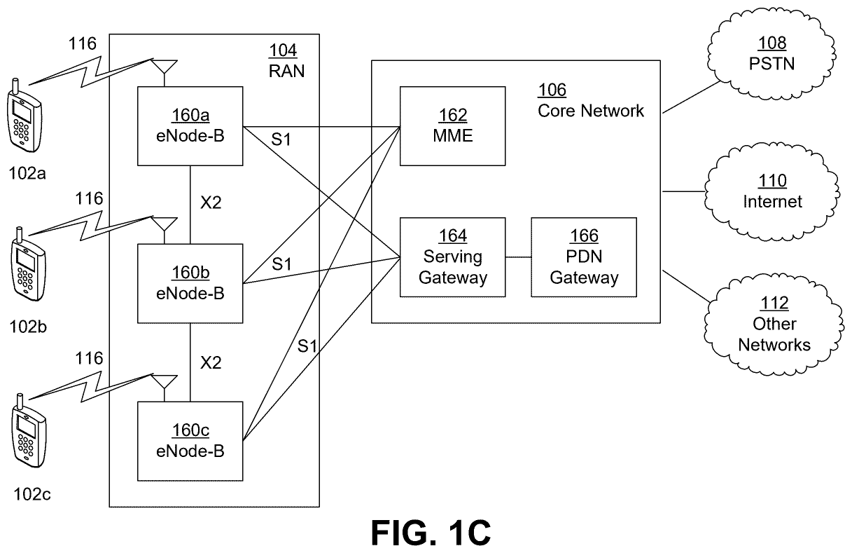

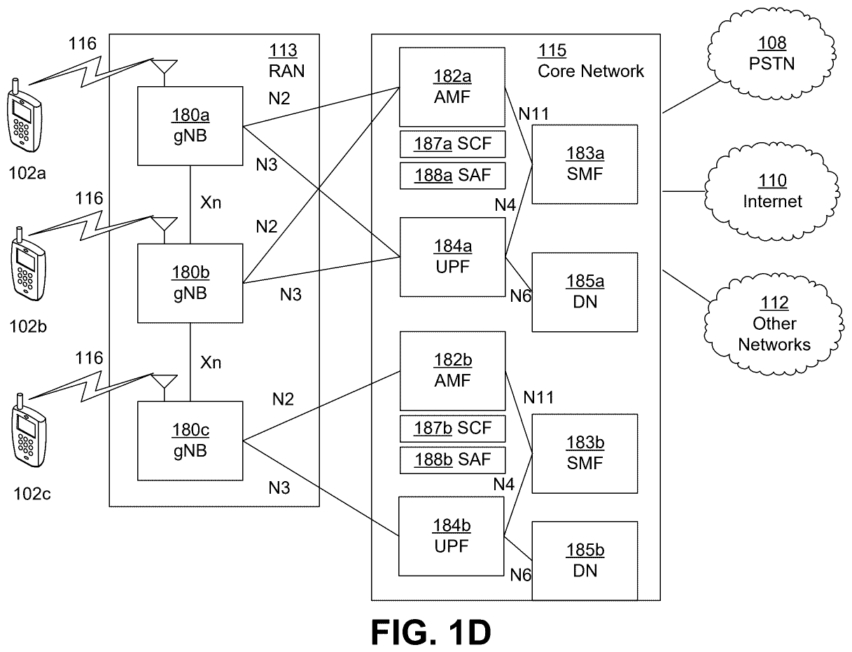

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network. As referred to herein, the term wireless network does not include a Wi-Fi network.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In accordance with some embodiments of this disclosure, methods and system for wireless cellular network (e.g., 6GS) registration, discovery, coordination, control and collection for non-cellular (e.g., Wi-Fi) sensing tasks are provided as follows. In some embodiments, the WTRU sends a capability registration request to a network function (NF) or application function (AF) (e.g., Sensing Enabler Server (SES)). The message may include a WTRU ID, non-cellular (e.g., non-3GPP) sensors supported, Wi-Fi sensing supported, Wi-Fi performance indicators, or any combination thereof. The WTRU may receive a capability registration response from the NF/AF. For multi-WTRU scenarios, the WTRU may receive a Wi-Fi broadcast request from an AF (e.g., SES) with a SSID and publishing range to begin broadcasting Wi-Fi sensing services. For multi-WTRU scenarios, the WTRU may send a Wi-Fi broadcast response to an AF (e.g., SES) with an accept or reject of the Wi-Fi broadcast request. The WTRU may receive a Wi-Fi status request from an AF (e.g., SES). The Wi-Fi status request may request the WTRU to respond with the current Wi-Fi status and list of connected Wi-Fi STAs. The Wi-Fi status request may request the WTRU to inform an AF (e.g., SES) about its Wi-Fi status (e.g., periodically, on events (e.g., network changed), or any combination thereof). The WTRU may send a Wi-Fi status response to an AF (e.g., SES) with its Wi-Fi status, sensing capabilities of Wi-Fi APs and available STAs, or any combination thereof. The WTRU may receive a Wi-Fi search request from an AF (e.g., SES) with a request to scan for SSIDs, get their relative distances, a list of SSIDs to filter, or any combination thereof. The WTRU may send a Wi-Fi search response to an AF (e.g., SES) with a list of discovered Wi-Fi APs, Wi-Fi STAs, their IDs, received signal strength, supported sensing modes, relative distances, or any combination thereof. The WTRU may receive a sensing service request from an AF (e.g., SES) with parameters received from a NF (e.g., SCF) and/or parameters decided by an AF (e.g., SES). The WTRU may decide and configure parameters for a sensing service task locally based on a sensing service request. The WTRU may communicate with Wi-Fi APs/STAs to ensure that the sensing task can be executed. The WTRU may send a sensing service response to an AF (e.g., SES) with acceptance or rejection of a Wi-Fi sensing task, with a list of rejection reasons, or any combination thereof. The WTRU may send a stream of data in the form of sensing service data with sensing task ID, sensing data and/or sensing results, metadata, or any combination thereof to an NF (e.g., sensing analytics function (SAF), location management function (LMF), network data analytics function (NWDAF)), an AF (e.g., SES), or any combination thereof.

In some embodiments, an NF (e.g., SCF, SAF) receives an AF registration request from an AF (e.g., SES) with an AF ID, non-cellular (e.g., non-3GPP) sensors that can be supported (e.g., Wi-Fi), location where these services can be offered, or any combination thereof. The NF may send a message acknowledging the registration request to an AF. The NF may receive a sensing service request from an AF or detect a KPI violation in an ongoing sensing task and choose to initiate a discovery of non-cellular (e.g., non-3GPP, Wi-Fi) sensing entities. The NF may send a sensing assistance request to an AF (e.g., SES) with WTRU ID(s), TSSA, sensing object, sensing data/results format, KPI requirements, data endpoint, data path, time, or any combination thereof. The NF may receive a sensing assistance response with a sensing task ID, an indication of whether KPIs can be met or not, a number and/or list of Wi-Fi entities (e.g., WTRUs, APs, STAs) that have been discovered by the AF (e.g., SES), a list of Wi-Fi specific parameters that can be used to plan a Wi-Fi sensing task, or any combination thereof. The NF may generate a list of configuration parameters for a Wi-Fi sensing task with a list of Wi-Fi APs/STAs, their role, Wi-Fi related parameters (e.g., bandwidth, frequency, serial bus protocol (SBP)), reporting interval, processing flow, or any combination thereof. The NF may send and receive sensing assistance task accept/reject and sensing assistance task begin/termination to/from an AF (e.g., SES) with a sensing task ID, parameters decided in previous steps, or any combination thereof. The NF may receive sensing service data with sensing task ID, sensing data and/or results, metadata, or any combination thereof.

In accordance with some embodiments of this disclosure, example scenarios in which non-cellular (e.g., non-3GPP, Wi-Fi) sensing may be used are provided as follows. Non-cellular (e.g., non-3GPP) sensors may be additional sources of information, provide sensing information where wireless cellular network (e.g., 3GPP) sensing is unavailable, be supplementary sensing source, or any combination thereof. Non-cellular (e.g., non-3GPP) sensing data may be non-RF based (e.g., cameras, LiDAR, IMU) or RF-based (e.g., Wi-Fi, BLE, UWB, radar).

Wi-Fi has several modes that may allow a Wi-Fi sensing client to configure the sensing task based on its requirements. When a wireless cellular network (e.g., 6GS) uses Wi-Fi sensing for its wireless cellular network (e.g., 3GPP) sensing tasks, the network may act as the application that controls the lifecycle of a Wi-Fi sensing task.

Wi-Fi sensing may be performed, coordinated through a Wi-Fi access point (AP), Wi-Fi station (STA) that implement 802.11bf or any other Wi-Fi sensing standards developed in the future. These access points may be wireless cellular network (e.g., 3GPP) managed or wireless cellular network unmanaged. Wireless cellular network (e.g., 3GPP) managed access points may be the ones used when the mobile network operations (MNOs) deploy their own Wi-Fi infrastructure and enable the use of Wi-Fi access points as non-cellular access nodes (e.g., non-3GPP access nodes (N3AN)). Non-cellular (e.g., non-3GPP) controlled access points may be used in scenarios in which the MNO/Core Network control of the APs are not required or cannot be provided. Therefore, these non-cellular (e.g., non-3GPP) controlled APs may still be beneficial to wireless cellular network (e.g., 3GPP) sensing tasks, if they offer sensing capabilities.

Additionally, there are a large number of Wi-Fi-enabled STAs available (e.g., mobile phones, IoT devices) with optional wireless cellular network (e.g., 3GPP) capabilities. These STAs may provide additional degrees of freedom (e.g., sensing data from another vantage point or a sensing technology), which may aid in sensing tasks.

Wi-Fi-sensing may provide better performance and higher quality sensing data in comparison to wireless cellular network (e.g., 3GPP) sensing. For example, the wireless cellular network (e.g., 3GPP) system may detect that some KPIs of a sensing service it provides are being violated, and as a result, may choose to use non-cellular (e.g., non-3GPP) sensing data to augment its service.

Wi-Fi sensing may be used for ISAC. For example, Wi-Fi sensing data may be used for improving wireless cellular network (e.g., 3GPP) communication (i.e., sensing for communication scenarios).

The wireless cellular network (e.g., 3GPP) may plan a wireless cellular network sensing task and choose to use non-cellular (e.g., non-3GPP) sensing data instead of the cellular (e.g., 3GPP) sensing data. It may do this based on pricing related reasons, lack of sensing coverage, to offload and/or balance its wireless cellular network (e.g., 3GPP) sensing, or any combination thereof.

In accordance with some embodiments of this disclosure, definitions for sensing data, sensing services, sensing tasks, sensing areas, and sensing results are provided as follows.

As referred to herein, sensing data may be the 6G or non-6G data produced for sensing purposes.

As referred to herein, a sensing service may be a feature of the wireless cellular network (e.g., 6GS) that is offered to service consumers. A sensing service may provide sensing results based on communicated requirements and KPIs.

As referred to herein, a sensing task may consist of activities to perform sensing, including the configuration of the required sensing transmitter(s) and sensing receiver(s), the collection of sensing data, the processing of the sensing data, the exposure of the sensing results, or any combination thereof. Each sensing task may fulfil a sensing service request.

As referred to herein, a sensing area may be a cartesian location area or a description of a geometrical 2D or 3D shape (e.g., a circle, an ellipse, a cube, a pyramid) combined with a sensing range. The sensing area may be centered around a sensing receiver. If the sensing area is a geometrical shape, the provided sensing service KPIs may be fulfilled within the provided sensing range. If the sensing area is a cartesian location, the sensing service KPIs provided by the sensing service consumer may be fulfilled within the entire sensing area.

As referred to herein, sensing results may include characteristics of objects (e.g., type, distance, velocity, trajectory, size, shape, material), other contextual information (e.g., time of generation, environmental information) about objects in the sensing area, or any combination thereof.

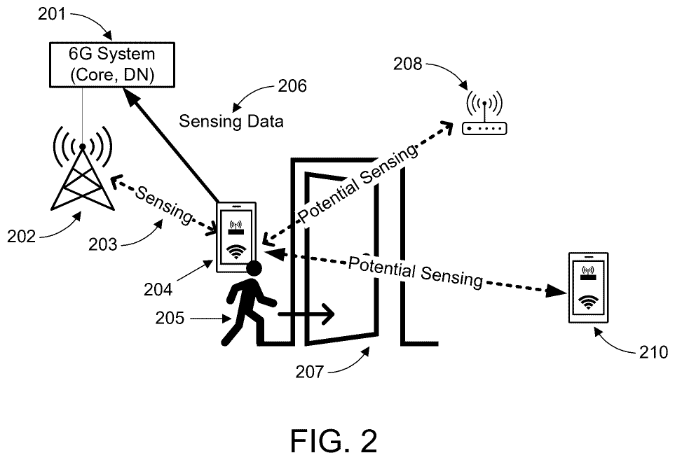

FIG. 2 is an illustrative diagram of a Wi-Fi sensing scenario, according to some embodiments of this disclosure.

In some embodiments, sensing data 206 is reported to the 6G network (e.g., 6G System 201) via NFs or UPFs. A sensing object and/or sensing WTRU (e.g., WTRU 204) may be moving indoors (e.g., by being carried by user 205 through door 207) into an area with possibly known Wi-Fi coverage (e.g., via Wi-Fi router 208). Wi-Fi APs and STAs may be available indoors to be used for sensing and may be chosen as potential sensing responders. In some embodiments, WTRU 204 senses WTRU 210.

In accordance with some embodiments of this disclosure, functionalities of an SCF, SAF, SES, SEC, WTRU, and Wi-Fi AP are provided as follows.

As referred to herein, the SCF may be a logical function that coordinates the sensing activities of the sensing system. The SCF may request sensing service requests and KPIs from AFs, or other network functions. The SCF may have procedures to retrieve information about WTRUs and their capabilities. The SCF may be responsible for scheduling of sensing tasks, deciding the sensing transmissions (TXs) and receptions (RXs) and other functions, or any combination thereof.

As referred to herein, the SAF may be a logical function in the wireless cellular network (e.g., 3GPP). The SAF may reside as an independent network function or as part of other existing network functions (e.g., NWDAF, SCF). The SAF may be responsible for collection and processing of sensing results, checking KPI violations, reporting the sensing results to the sensing service requester, or any combination thereof.

As referred to herein, the SES may be a logical function that may run as part of the network or outside the network, as a vertical application layer (VAL) server, service enabler architecture layer (SEAL) application, as an AF or AS, an enabler server, as a network function within the network, as part of the SCF, or any combination thereof. The SES may be responsible for interacting with the application on the WTRU (e.g., SEC) and may coordinate Wi-Fi sensing activities on the WTRU. Parts of SES may also be implemented in the SEC.

As referred to herein, the SEC may be a logical function that runs on the WTRU. It may run as part of an application on the WTRU, installed by an MNO, device manufacturer, users, or any combination thereof. The SEC may also be part of the modem. The SEC may be the function that may interact with the Wi-Fi sensing chips, cellular modem, processing entities on the WTRU, or any combination thereof.

The modem and WTRU application (e.g., SEC) may be depicted separately. This has been done to depict different physical and logical blocks in the WTRU for Wi-Fi coordination and wireless cellular network (e.g., 3GPP) coordination (e.g., modem). However, both of these may be part of the modem, or run as separate applications.

As referred to herein, Wi-Fi access points may be devices that act as gateways for wireless STAs to connect to a wired backhaul network. Wi-Fi Aps may support the 802.11bf (WLAN sensing) standard and 802.11az (ranging) standard. Although the 802.11bf is an extension to the 802.11az standard, this distinction is made to ensure that the Wi-Fi APs may support both ranging and sensing. Additionally, Wi-Fi APs in this paper may be connected to an MNO-controlled non-cellular (e.g., non-3GPP) interworking function (N3IWF) for their backhaul network. In current 5G specifications, N3IWF is the NF that allows untrusted Wi-Fi APs to interface with the wireless cellular network (e.g., 3GPP). In future specifications, this functionality may be extended or modified into a new NF.

The SCF described herein may represent a new NF in 6G or its functionality may be added to an existing 5G NF. The SAF described herein may represent a new NF in 6G or its functionality may be added to an existing 5G NF.

In accordance with some embodiments of this disclosure, two types of registrations for the integration of Wi-Fi sensing in wireless cellular network (e.g., 6GS) are provided as follows.

In some embodiments, the integration of Wi-Fi sensing in wireless cellular network is done by registering the SEC to the SES. For example, the WTRU (e.g., SEC) may register their Wi-Fi sensing capabilities with the SES. This allows the SES to know the list of WTRUs that it may use for Wi-Fi sensing tasks.

In some embodiments, the integration of Wi-Fi sensing in wireless cellular network is done by registering the SES to the SCF. For example, the SES may register with an NF (e.g., network repository function (NRF), network exposure function (NEF), SCF) with information that the SCF may use to request for Wi-Fi sensing activities.

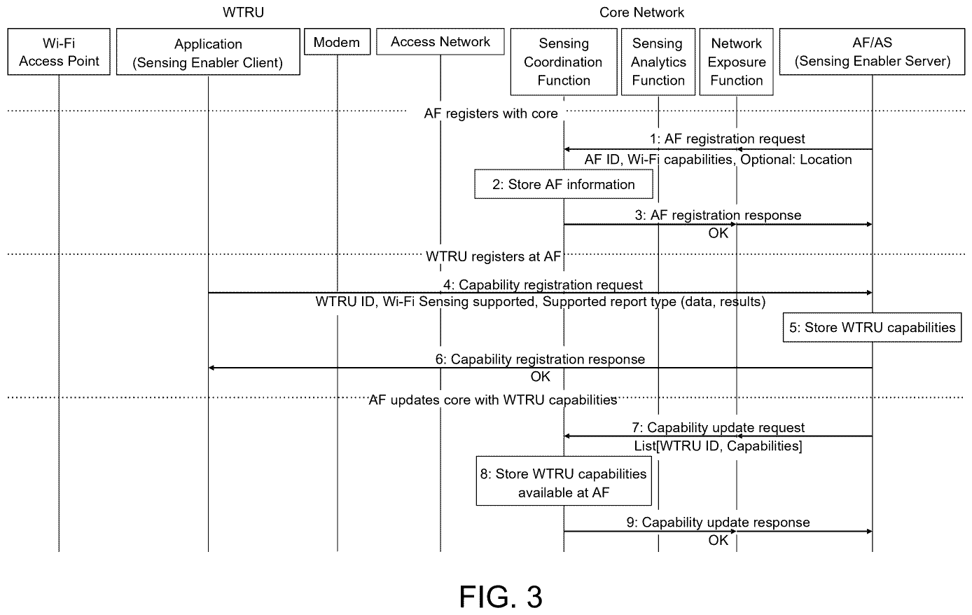

FIG. 3 is an illustrative flow diagram of steps for registering of SEC to SES and SES to SCF, according to some embodiments of this disclosure.

In some embodiments, at step 1 of FIG. 3, the SES sends an AF registration request to the SCF (e.g., via the NEF if required). The request may consist of an AF ID, capabilities that SES can provide (e.g., Wi-Fi sensing, sensing frequency bands, non-cellular (e.g., non-3GPP) sensors), the location where the SCF can perform the registration, a list of WTRUs that have already registered, or any combination thereof.

In some embodiments, in the registration request, the SES also includes information related to charging or incentivization techniques. As part of this request, if the SES provides a list of WTRUs, the wireless cellular network (e.g., 3GPP) may use this information to keep track of the incentivization and charging information. For example, the wireless cellular network may increase the incentivization value it gives to the WTRU for participating in Wi-Fi (i.e., non-cellular (e.g., non-3GPP)) sensing tasks on behalf of the wireless cellular network (e.g., 3GPP) with monetary incentives (e.g., by not charging it for the data, by providing free sensing services, or any combination thereof).

In some embodiments, at step 2 of FIG. 3, the SCF stores the information from step 1 of FIG. 3 for future use.

In some embodiments, at step 3 of FIG. 3, the SCF sends an AF registration response to the SES in response to the request from step 1 of FIG. 3. The response may include a response status field indicating the SCF's ability to process the request correctly. If the SCF was not capable of processing the request, the response status field may indicate the error (e.g., using HTTP response codes).

In some embodiments, the SCF along with other NFs or operations, administration, and maintenance (OAM) may decide the incentivization that it may offer to the SES and report the incentivization as part of the AF registration response.

In some embodiments, at step 4 of FIG. 3, the WTRU (e.g., after booting, after resetting, after application install, after reconfiguration, on request from the cellular network) initiates a capability registration request towards the SES. Initiating the capability registration request may be done after querying the local interfaces to receive information about its Wi-Fi sensing capabilities. The fully qualified domain name (FQDN) or IP address identifying the SES may be pre-configured in the WTRU. The SEC may receive the IP address or FQDN through NRF, common API framework (CAPIF), NEF, any other network function that holds a database of SES addresses, or any combination thereof.

The registration request may consist of the WTRU ID, Wi-Fi sensing supported modes, Wi-Fi sensing performance information (e.g., metadata information stored while manufacturing or calibration), processing abilities (e.g., processing capabilities (e.g., floating-point operation capabilities)), sensing report type, user/WTRU related information, consent information, or any combination thereof.

The WTRU ID may be an IP address, subscription permanent identifier (SUPI), subscription concealed identifier (SUCI), international mobile subscriber identity (IMSI), any other identifier that can be used to uniquely identify a WTRU in a network (e.g., FQDN), or any combination thereof. The WTRU ID may need to be resolved at the SES by communicating with appropriate NFs (e.g., directly, via NEF).

The sensing report type may consist of the type of information that can be accessed by the SEC from the Wi-Fi adapter/chip or the operating system. For example, a Wi-Fi sensing adapter may expose sensing data (i.e., channel state information (CSI), time of flight (ToF)) or sensing results (e.g., number of objects). Whether sensing data or sensing results are available may be up to implementation or the Wi-Fi APIs that are standardized. There may also be privacy constraints based on the type of information that may be exposed.

Wi-Fi sensing performance indicators may be two types of information. The first type of information may be any calibration metrics and/or parameters that are stored in the Wi-Fi adapter/chip during the manufacturing and calibration phase and may be useful to better characterize the sensing data reported by sensing receivers. For example, the information may specify whether any processing, such as compression, is performed on the data, carrier frequency offset, received signal strength calibrations, or any combination thereof. The second type of information may be indicators that may be reported at runtime (e.g., accuracy, latency, jitter, indicators of interference). Although the information may only be available at runtime, the parameters that can be reported may be part of the registration request and may be used by the network to better decide what information may be useful for the network.

The message may comprise information related to the user, the WTRU, associated Wi-Fi networks, or any combination thereof. For example, the message may include specific information about the WTRU, the user, a current list of Wi-Fi networks that the WTRU has associated with in the past, any other information related to those Wi-Fi networks that the WTRU may have based on past interactions with the Wi-Fi Aps, or any combination thereof.

The message may indicate whether Wi-Fi sensing data may be provided by the WTRU and whether it could be shared with a wireless cellular network (e.g., 3GPP).

In some embodiments, at step 5 of FIG. 3, the SES stores the information provided from step 1 of FIG. 3 locally for future use.

In some embodiments, at step 6 of FIG. 3, the SES sends a capability registration response with an acknowledgement to the WTRI in response to the request from step 1 of FIG. 3. If the request is malformed or the SES runs into any internal issue, the SES may send a capability registration response with an error code indicating the type of issue to the WTRU.

In some embodiments, at step 7 of FIG. 3, during run-time (e.g., periodically, on WTRU registration updates), the SES sends a capability update request to the SCF with the list of known WTRUs and their sensing capabilities.

In some embodiments, at step 8 of FIG. 3, during run-time (e.g., periodically, on WTRU registration updates), the SCF stores the new or updated WTRU capabilities provided by the SES in step 7 of FIG. 3.

In some embodiments, at step 9 of FIG. 3, during run-time (e.g., periodically, on WTRU registration updates), the SCF sends a capability update response to the SES (e.g., via NEF if needed) informing the SES about the processing of the request in step 7 of FIG. 3. The response may include a status allowing the SCF to also indicate potential errors when processing the request.

In accordance with some embodiments of this disclosure, possible triggers and discovery scenarios are provided as follows.

Wi-Fi sensing may be useful to the network for the following reasons: (1) Wi-Fi APs and STAs may be closer to a sensing object being tracked. (2) Wi-Fi APs and STAs may provide additional sensing degrees of freedom. (3) Wireless cellular network (e.g., 3GPP) sensing signal strength in an indoor environment may be weak. (4) Wi-Fi sensing may be more cost-effective to perform than wireless cellular network sensing. (5) Wi-Fi sensing may aid and improve wireless cellular network communication. (6) Wireless cellular network sensing may not be available in the area for technical and/or non-technical reasons (e.g., wireless cellular network sensing may not be permitted in an area but Wi-Fi sensing may be allowed).

There may be two possible scenarios of how the SCF triggers and chooses to use Wi-Fi sensing. The first scenario may be when a wireless cellular network (e.g., 3GPP) receives a sensing service request, while it performs discovery of sensing TXs/RXs, it may perform discovery of Wi-Fi sensing WTRUs that may assist in the sensing task. The second scenario may be when Wi-Fi sensing is used as additional assistance information that may be leveraged for ISAC. For example, if a wireless cellular network is executing a sensing service request and detects that KPIs are being violated, it may choose to use non-cellular sensing data to aid its service.

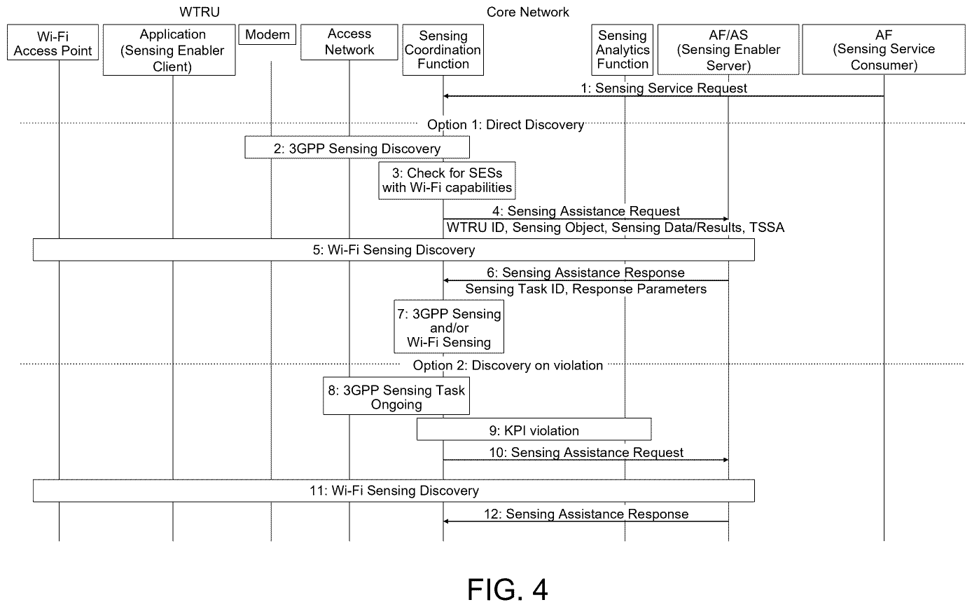

FIG. 4 is an illustrative flow diagram of steps for trigger and discovery scenarios for Wi-Fi sensing, according to some embodiments of this disclosure.

In some embodiments, at step 1 of FIG. 4, the sensing service consumer (e.g., AF) sends a sensing service request to the SCF. The parameters for the sensing service request may be information about the sensing object, the sensing area within sensing should take place, the KPIs for the sensing results, expected data formats for the sensing results, or any combination thereof.

In some embodiments, at step 2 of FIG. 4, the SCF performs a discovery of wireless cellular network (e.g., 3GPP) sensing TXs/RXs to create a sensing task serving the sensing service requested in step 1 of FIG. 4.

In some embodiments, at step 3 of FIG. 4, the SCF checks for known Wi-Fi sensing resources by using SES information received when SESs registered with the network and the SES provided updates about known sensing capabilities.

In some embodiments, at step 4 of FIG. 4, the SCF sends a sensing assistance request to the SES.

In some embodiments, at step 5 of FIG. 4, the SES performs Wi-Fi sensing discovery.

In some embodiments, at step 6 of FIG. 4, the SES responds with a sensing assistance response to the SCF.

In some embodiments, at step 7 of FIG. 4, the SCF determines the type of sensing it would like to perform. The SCF may choose to use either wireless cellular network sensing or non-cellular (e.g., Wi-Fi) sensing, or it could choose to use both. The choice for the SCF can depend on the guarantees that the sensing systems can provide based on a number of WTRUs, charging and incentivization reasons, service requirements from the sensing service request received in step 1 of FIG. 4, or any combination thereof.

In some embodiments, at step 8 of FIG. 4, the SCF may have a wireless cellular network sensing task that is ongoing based on a sensing service request from an AF or any other system component (e.g., WTRU, base station (BS), NF).

In some embodiments, at step 9 of FIG. 4, the SAF detects that there has been a KPI violation and informs the SCF about this KPI violation. KPI violations may be due to mobility, weak sensing coverage, cell coverage not being available, a sensing object or WTRU moving indoors where coverage is unfavorable, or any combination thereof. The SCF may attempt to update the wireless cellular network sensing groups (e.g., add, remove, or update a list of WTRUs or BSs), change sensing modes, choose to take assistance from Wi-Fi sensing or other non-cellular (e.g., non-3GPP) sensors by choosing the AFs that can assist it in its sensing service task, or any combination thereof. The SCF may decide to seek assistance from non-cellular (e.g., Wi-Fi) sensing data.

In some embodiments, at step 10 of FIG. 4, the SCF sends a sensing assistance request to the SES.

In some embodiments, at step 11 of FIG. 4, the SES performs Wi-Fi sensing discovery.

In some embodiments, at step 12 of FIG. 4, the SES responds with a sensing assistance response to the SCF.

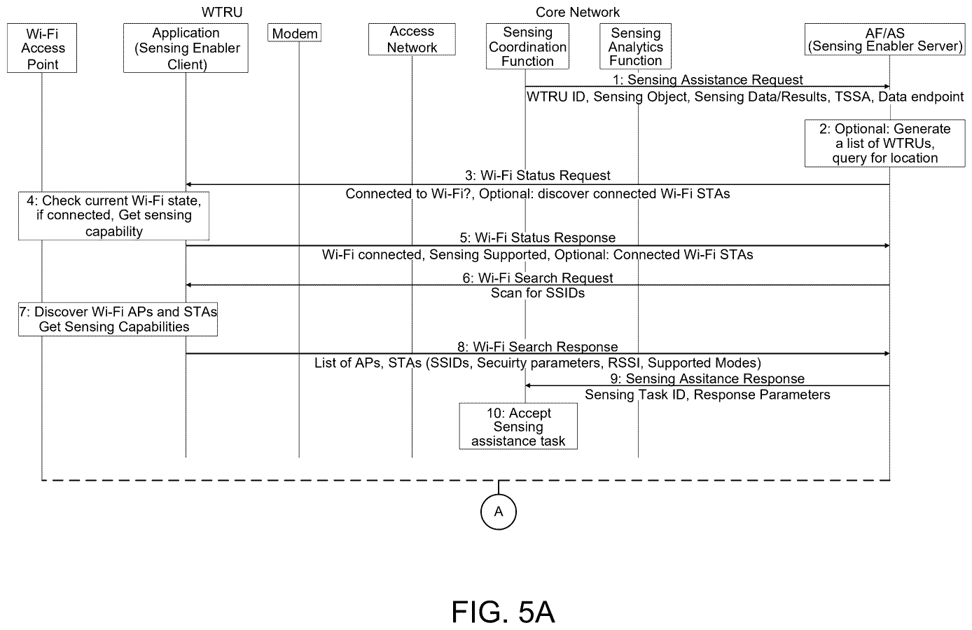

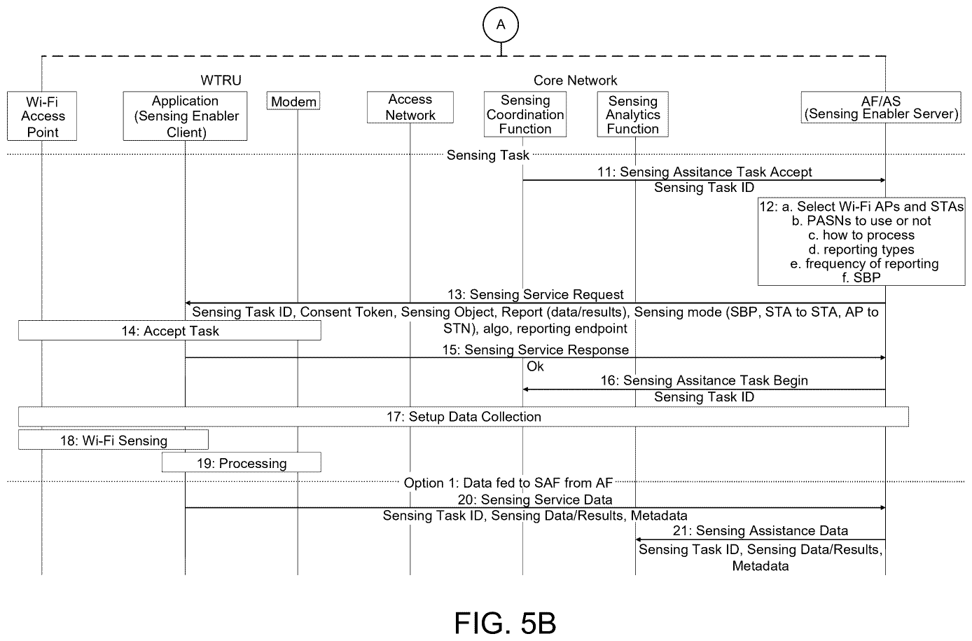

FIG. 5A is a first portion of an illustrative flow diagram of steps for wireless cellular network (e.g., 6GS) controlled Wi-Fi sensing, according to some embodiments of this disclosure.

All procedures in FIG. 5A and FIG. 5B refer to a WTRU when dealing with any procedure that may be performed by the SEC, a modem, or any other functionality on the WTRU. A function is explicitly called out when referring to a specific functionality that can differentiate between the WTRU as a whole and a part of the WTRU.

In some embodiments, at step 1 of FIG. 5A, once the SCF has decided to seek assistance from non-cellular (e.g., Wi-Fi) sensing data, it sends a sensing assistance request to the SES. The sensing assistance request may consist of any one or more of the following options:

The sensing assistance request may consist of a WTRU ID (e.g., IP address, FQDN, SUPI, SUCI, IMSI). If a sensing task is pinned to a WTRU, or if the network has identified that a particular WTRU is in a favorable position for a sensing task, the sensing assistance request may consist of the WTRU ID. The WTRU ID may be a list of one or more WTRUs, wherein if the SCF already is aware of WTRUs that are close to each other, the SCF may inform the SES about the WTRUs, and the SES may skip discovery of other WTRUs and begin coordination and collection of Wi-Fi sensing task.

The sensing assistance request may consist of a sensing object. If the SCF determines that it wants the SES to track a particular sensing object and is interested directly in sensing results, it can add this as part of the request to inform the SES to focus only on this sensing object.

The sensing assistance request may consist of a TSSA. The TSSA is an essential parameter that the SCF may include as part of the request. The TSSA may allow the SES to only target WTRUs that can perform sensing in a particular area. The SES may use the TSSA, along with the location functionalities provided by wireless cellular network, to find a list of WTRUs.

The sensing assistance request may consist of sensing data and/or sensing results. The SCF may further determine whether it would prefer the SAF to receive sensing data and process it into sensing results or directly receive the sensing data for further potential processing. This determination may depend on what the SAF can process, the kind of bandwidth it can allocate to a WTRU specified with a WTRU ID (e.g., based on communication with other NFs), incentivization (e.g., price for sensing data and sensing results), or any combination thereof.

The sensing assistance request may consist of KPI requirements. The SCF may specify the KPI requirements for the Wi-Fi sensing task. The KPI requirements for the Wi-Fi sensing task may be based on the minimum resolution needed, accuracy of positioning, velocity, confidence level, sensing range, refresh rate, latency requirements, or any combination thereof. The KPIs may be derived or copied over from the sensing service request received from the sensing service consumer (e.g., the SES, another NF, a BS, the WTRU).

The sensing assistance request may consist of a data endpoint. The SCF may specify the data endpoint for where it wants the sensing data or sensing results to be sent to. The data endpoint may be the address for SAF, another NF, a particular WTRU address, RAN node address, or somewhere in the data network. The address may be a name, IP address, FQDN, any other form of identification, or any combination thereof.

The sensing assistance request may consist of a datapath. The SCF may determine (e.g., by communicating with other NFs) the most optimal path for data to be collected from a particular WTRU. Further details about this are provided in step 20 of FIG. 5B.

The sensing assistance request may consist of a time. The time may indicate when to perform sensing or when the sensing data may be needed. The time may specify information about events (e.g., upon receiving a message from the network) that may be used as triggers to start sensing or for sending sensing data. A timer value that may be associated with the task may be provided to decide when to terminate or stop a task.

In some embodiments, at step 2 of FIG. 5A, if the sensing assistance request from step 1 of FIG. 5A does not comprise one or more WTRU IDs (i.e., particular WTRUs to perform Wi-Fi sensing), the SES generates a list of suitable WTRUs that can aid in the sensing task. The SES may generate the list of suitable WTRUs by querying other NFs, SEAL servers, Afs, or any combination thereof to obtain location information about the WTRUs. The SES further down may select WTRUs based on information such as capabilities, incentivization, availability (e.g., battery), or any combination thereof. The SES may also down select WTRUs in step 12 FIG. 5B (e.g., The SES may perform a Wi-Fi status discovery and then down select the WTRUs).

In some embodiments, at step 3 of FIG. 5A, the SES sends a Wi-Fi status request to the WTRU (e.g., SEC) to query the WTRU's current Wi-Fi status. The Wi-Fi status request may consists of any one or more of the following parameters.

The Wi-Fi status request may consist of an indication of whether the WTRU is currently connected to a Wi-Fi network or not.

The Wi-Fi status request may consist of a list of STAs that are connected to a Wi-Fi AP. If the WTRU is associated with a Wi-Fi network and the privacy policy allows the WTRU to perform a network scan (e.g., via Internet Control Message Protocol version 4 (ICMPv4) or Internet Control Message Protocol version 6 (ICMPv6) echo requests for IP-based WTRU identification or address resolution protocol (ARP) scan/sweeps for MAC-only-based STA identification), the WTRU may generate a potential list of other STAs that are associated with the same Wi-Fi network and may potentially aid in the sensing task.

The Wi-Fi status request may consist of ranging measurements. The SES may request WTRUs to perform ranging measurements with the APs and STAs that have been identified.

The Wi-Fi status request may consist of processing nodes. The SES may request WTRUs to discover local processing nodes (e.g., routers, IoT hubs) that may assist WTRUs in processing the data.

In some embodiments, at step 4 of FIG. 5A, the WTRU checks its current Wi-Fi status by interacting with the appropriate APIs on the WTRU. If the WTRU is associated with a Wi-Fi AP, the WTRU may obtain a list of sensing capabilities supported by the Wi-Fi AP. Additionally, the WTRU may obtain a list of STAs on the network by performing a network scan (e.g., while respecting any privacy policies that might be in place).

In some embodiments, at step 5 of FIG. 5A, the WTRU sends a Wi-Fi status response to the SES. The Wi-Fi status response may consist of the current Wi-Fi status, received signal strength, sensing capabilities of the AP (e.g., whether 802.11bf is supported, whether SBP is supported), whether STAs were discovered on the network, a list of STAs with their MAC and/or IP addresses, their relative distances, or any combination thereof.

In some embodiments, the SES requests the WTRU to update the SES about its network state when it changes (e.g., Wi-Fi gets connected or disconnected). The Wi-Fi status may also be part of a periodic, aperiodic, or event-based Wi-Fi status response message.

In some embodiments, at step 6 of FIG. 5A, the SES optionally decides to get WTRUs to perform more scanning. This decision may be based on the Wi-Fi connection status of the WTRUs, the number of STAs discovered, whether the number of STAs discovered is sufficient, or any combination thereof. The SES may request WTRU to perform this scan to gather additional information to make better informed decisions in step 12 of FIG. 5B. The SES may send a Wi-Fi search request to the WTRU with a request to scan for nearby SSIDs. The SES may restrict the list of SSIDs or services to scan to reduce the potential list of sensing entities. The SES may request WTRUs to perform ranging measurements with the APs and STAs.

In some embodiments, at step 7 of FIG. 5A, upon receiving the request in step 6 of FIG. 5A, the WTRU performs an SSID scan and obtains a list of all APs in range and nearby STAs that are broadcasting information (e.g., ad-hoc mode, Wi-Fi direct, P2P mode). The information may consist of the capabilities of the devices (e.g., whether they support sensing or not) through sending a probe request frame, probe response frame, association response frame, reassociation response frame, association request frame, reassociation request frame, measurement query frame, or any combination thereof to an AP and other STAs in the network. The AP's sensing capabilities may be broadcasted as part of AP's broadcast frames.

In some embodiments, at step 8 of FIG. 5A, the WTRU sends the list of available APs/STAs to the SES in a Wi-Fi status response message. The Wi-Fi status response message may consist of a list of SSIDs, security parameters, sensing capabilities and received signal strength, relative distance to Wi-Fi APs and STAs, or any combination thereof.

In some embodiments, at step 9 of FIG. 5A, the SES sends a sensing assistance response to the SCF. The sensing assistance response may consist of a sensing task ID (STID) generated by the SES, charging or incentivization schemes, an indication of whether the SES can meet the KPI requirements specified by the SCF or not, or any combination thereof. The STID may be an identification for the sensing task at the SES.

In some embodiments, at step 10 of FIG. 5A, based on the response gathered from the SES in step 9 of FIG. 5A and from wireless cellular network sensing entities, the SCF decides to accept or reject the sensing assistance the SES can provide. If the SCF accepts the sensing assistance information from the SES, the next steps below may be performed. If SCF chooses to reject the sensing assistance information from the SES, the SCF may inform the SES of the same, so that the SES can free up any internal state in relation to the sensing task ID and tear down any connections the SES may have made.

FIG. 5B is a second portion of an illustrative flow diagram of steps for wireless cellular network (e.g., 6GS) controlled Wi-Fi sensing, according to some embodiments of this disclosure. Steps 11-21 of FIG. 5B focus on the Wi-Fi sensing task, how it is performed, and how the data is gathered once the SCF has accepted the sensing assistance.

In some embodiments, at step 11 of FIG. 5B, the SCF sends a sensing assistance task accept to the SES with the Sensing Task ID.

In some embodiments, at step 12 of FIG. 5B, the SES uses the list of gathered Wi-Fi statuses from WTRUs and plans the sensing task(s). The SES may plan one or more sensing tasks on the same WTRU or on different WTRUs depending on the requirements received in the sensing assistance request. The output parameters for this decision may consist of any one or more of the following.

The output parameters may consist of a number of sensing tasks or initiators. The SES may choose one or more WTRUs to be the sensing initiators and may create multiple sensing tasks for each of the chosen WTRUs.

The output parameters may consist of a list of sensing responder Wi-Fi AP/STAs. The SES may choose a list of APs and STAs based on the requirements of the sensing task. The SES may decide which APs or STAs need to be sensing transmitted, received, or both. At steps 3 and 6 of FIG. 5A, the SES may request to perform ranging measurements based on the 802.11az specifications with the APs to get their positions. The decision to choose which APs/STAs may be based on the received signal strength or other information that the SES may have about these APs/STAs (e.g., trustworthiness based on past performance).

As part of sensing assistance request, the SCF may send a list of WTRU IDs that are already part of the sensing task. These WTRUs may be already in each other's vicinity and the SES may not need to spend resources trying to discover each other may proceed to use them for a Wi-Fi sensing task directly.

The output parameters may consist of security information. If the APs or STAs require a secured connection to perform sensing, the SES may have keys for that. The SES may have collected these access keys through 3rd party agreements or through the core network via WLAN selection policy (WLANSP) policies. If the APs support pre-association security negotiation (PASN), the SES may use PASN to increase security for sensing tasks. The SES may generate temporary keys, as the 802.11bf specifications allow keys to be generated on the STAs directly.

The output parameters may consist of an SBP mode. Based on the location of APs, STAs and their capabilities, the SES may choose to use an SBP mode for sensing tasks. For example, if a WTRU was part of the sensing task but has moved far away from a sensing object, or the sensing object has moved outside the area the AP-STA can sense, the SES may use SBP if it is aware of other STAs connected to the same Wi-Fi network and closer to the object and ask the Wi-Fi AP to perform the sensing on its behalf.

The output parameters may consist of a processing flow. 802.11bf exposes CSI and ToF data to higher layers. The bandwidth requirements for these may be quite high to be transmitted back to the network. There may be a need to do some local processing to reduce the size of the data and use the uplink bandwidth efficiently. Further details about this are provided in step 19 of FIG. 5B.

The output parameters may consist of a frequency. Wi-Fi sensing may be performed in several bands (e.g., 2.4 GHz, 5 GHz, 60 GHz). The SES based on the type of sensing assistance request may choose the frequency band.

The output parameters may consist of a bandwidth. Wi-Fi sensing may be performed in several different bandwidths (e.g., 20 MHz, 40 MHz, 80 MHz, 160 MHz). The SES based on the type of request may choose the frequency band to perform sensing.

The output parameters may consist of a type of reporting. The SES may decide on the type of reporting that the WTRU should do for non-3GPP (e.g., Wi-Fi) sensing. The SES may choose whether WTRUs should report sensing data (e.g., CSI, ToF) or sensing results (e.g., a number of objects). The reporting information may consist of the reporting interval, reporting triggers (e.g., periodic, event-triggered) reporting endpoint (e.g., based on the data endpoint and datapath parameters received in step 1 of FIG. 5A), or any combination thereof.

In some embodiments, at step 13 of FIG. 5B, the SES sends a sensing service request to the WTRU with the list of parameters generated in step 12 of FIG. 5B. The list may consist of the sensing object (e.g., if sensing results are requested), data path, data endpoint, time to perform the operation (i.e., requirements communicated as part of the sensing assistance request), or any combination thereof.

In some embodiments, at step 14 of FIG. 5B, upon the WTRU reception of the service request, the WTRU initiates a Wi-Fi sensing request with the APs and STAs and waits for the task to be accepted. Once the AP/STA has accepted the task, the WTRU may accept the task on the wireless cellular network side. If there is incentivization involved for sensing tasks, the SES may have embedded incentivization numbers in the request and the WTRU may use these to choose to accept or reject a sensing task.

In some embodiments, at step 15 of FIG. 5B, the WTRU sends a sensing service response to the SES with an accept or reject for the sensing task. Rejection of the sensing task may be due to WTRU policies about energy states, incentivization, whether the Wi-Fi AP rejects the task with a new list of suggested parameters, if the AP declines the task because the request was malformed and did not have the required parameters, or any combination thereof.

In some embodiments, at step 16 of FIG. 5B, the SES sends a sensing assistance response with the sensing task ID to the SCF (e.g., the NF that requested these services). Once the SCF receives this sensing task ID, it may send a request to the data endpoint that was part of the request in step 13 of FIG. 5B. For example, if the SCF had requested sensing assistance data to be reported to an SAF, after receiving the sensing task ID, the SCF may inform the SAF to expect data with a sensing task ID and what corresponding wireless cellular network sensing task ID should it use the data for.

In some embodiments, at step 17 of FIG. 5B, setting up the data collection path is the step in which the WTRU sets up uplink paths to the function where data needs to flow. Collecting data from a WTRU performing Wi-Fi sensing may be done using any one or more of the following methods.

Collecting data from a WTRU performing Wi-Fi sensing may be done using a data network. If the WTRU is connected to a non-network connected Wi-Fi network, sensing data may flow over the data network (i.e., internet) to the SES. This may require the SES to send a destination address (e.g., SES IP address or FQDN) that is accessible to the WTRU from a public facing location.

Collecting data from a WTRU performing Wi-Fi sensing may be done using wireless cellular network user plane or data plane to an NF or application server (AS). As the WTRU is connected to the network (e.g., via UPF), the sensing data may be sent over this interface to an NF/AS. The UPF or an equivalent function in the data plane may act as the intermediary and may divert the packets to the NF or AS as requested.

Collecting data from a WTRU performing Wi-Fi sensing may be done using a wireless cellular network control plane to an NF/AF. As the WTRU is connected to the network (e.g., via NAS/N1), the sensing data may be sent over this interface to an NF or AF (e.g., via NEF if needed).

Collecting data from a WTRU performing Wi-Fi sensing may be done using a wireless cellular network control plane or user plane to an NF, AF, or AS via N3IWF: The WTRU may also be connected to Wi-Fi APs that have a backhaul to the MNO's N3IWF. In this case, data may flow through any of N3IWF's interfaces (e.g., N1, N2, N3).

In some embodiments, at step 18 of FIG. 5B, the WTRU along with Wi-Fi APs and STAs performs Wi-Fi sensing and obtains sensing data (e.g., CSI, ToF).

In some embodiments, at step 19 of FIG. 5B, based on the configuration received from the SES, the WTRU is instructed to perform processing on the sensing data. The processing may be done either at the SEC or on the modem (e.g., where the SEC inputs data to the modem to perform processing).

In some embodiments, at step 20 of FIG. 5B, the WTRU is configured to send sensing data directly to SES via one of the routes described above.

In some embodiments, the WTRU is configured to send sensing data or results directly to an NF (e.g., SAF) via one of the routes described above. The endpoint of the message may not be the SES, but rather another NF in the core network.

The WTRU may send the sensing service data to the desired endpoint based on the configuration. The message may consist of the sensing task ID, sensing data or results, the metadata information, or any combination thereof. Metadata information may consist of any one or more of an accuracy of the sensing data or sensing results, received signal strength, relative real-time locations of the APs or STAs, or a confidence interval.

In some embodiments, at step 21 of FIG. 5B, ff the SES was the endpoint of the sensing service data, the SES feeds this information to the actual endpoint (e.g., SAF) directly or via NEF. This may allow the SES to keep control of the data stream for accounting purposes. The SES may act as a function that ensures no private information is accidentally revealed and may filter this information appropriately.

In accordance with some embodiments of this disclosure, a teardown of a sensing task is provided as follows. Once the SCF is done with the sensing service assistance request, it may send a sensing service assistance task stop request to the SES with the sensing task ID. The SES may then terminate the tasks on the WTRUs and teardown any infrastructure (e.g., computing nodes, QoS paths) that it may have brought up for this sensing task. The SES may send a response to the SCF with the final charging numbers for accounting purposes.

In accordance with some embodiments of this disclosure, decisions of whether step 12 of FIG. 5B should be performed at the WTRU or shared between the WTRU and the SES are provided as follows. The SES may make decisions about all the parameters of a sensing task. The SES may act as a proxy for sensing service assistance request messages from the SCF and send these directly to the WTRU. The WTRU on its own may make the choice about what should be done, in terms of the Wi-Fi APs/STAs to use, processing to perform, and send the results directly to the endpoint specified in the message. This decision may also be shared between the WTRU and the SES based on the configurations and capabilities of the WTRU and the SES.

In accordance with some embodiments of this disclosure, decisions of whether step 12 of FIG. 5B should be performed at the SCF or shared between the SCF and the SES are provided as follows. The SES as part of sensing assistance response may share with the SCF a list of Wi-Fi APs/STAs, received signal strengths, relative distances, or any combination thereof. SCF may then plan the Wi-Fi sensing task, if it has the capability to do it. Planning a Wi-Fi sensing task may be similar to planning a wireless cellular network sensing task and similar techniques may be employed by the SCF. Once the SCF has planned this task and how it would like it to be executed, it may send a sensing assistance task accept to the SES with the planned task. The SES in this case may act as the proxy for SCF decisions and may send a sensing service request to the WTRUs with parameters decided by SCF.

In accordance with some embodiments of this disclosure, methods and systems for wireless cellular network controlled Wi-Fi based multi-UE sensing are provided as follows.

In some embodiments, the wireless cellular network (e.g., SES) has multiple WTRUs in a TSSA that may be potentially used for a sensing task. However, there may not be any means for them to be discovered and range each other without assistance from the wireless cellular network. Using multiple WTRUs controlled by wireless cellular network may allow the wireless cellular network to perform Wi-Fi sensing even in scenarios where there are no Wi-Fi sensing supported APs deployed.

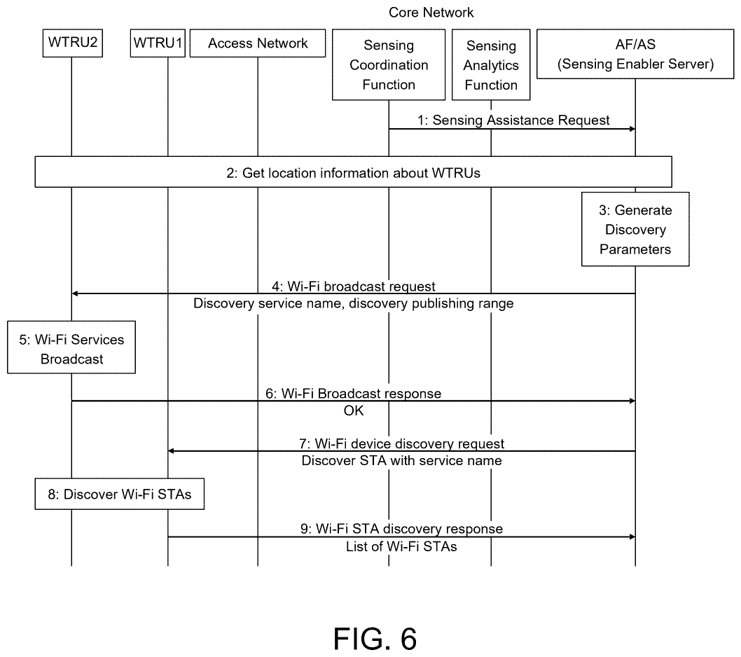

FIG. 6 is an illustrative flow diagram of steps for wireless cellular network controlled multi-WTRU discovery for Wi-Fi sensing, according to some embodiments of this disclosure. The procedure shows two WTRUs deployed in the same TSSA that the wireless cellular network needs to assist in discovery of using Wi-Fi. A wireless cellular network may use other means of discovery such as using the LMF to obtain precise locations or using Sidelink (PC5/ProSe). The wireless cellular network may also use Wi-Fi to allow WTRUs to discover each other.

In some embodiments, at step 1 of FIG. 6, the SES receives a sensing assistance request from the SCF with parameters as described in step 1 of FIG. 5A.

In some embodiments, at step 2 of FIG. 6, the SES obtains the location of all WTRUs (e.g., WTRU1 and WTRU2 in FIG. 6) through different means such as GPS, LMF, location SEAL server, or any combination thereof.

In some embodiments, at step 3 of FIG. 6, once the SES has obtained a list of WTRUs, it chooses a list of WTRUs that are in the desired TSSA. The SES may then choose one or more of the WTRUs as Wi-Fi discoverers and others as Wi-Fi broadcasters. The SES may decide the SSIDs, broadcasting range, a list of sensing configurations, or any combination thereof.

In some embodiments, at step 4 of FIG. 6, the SES sends a Wi-Fi broadcast request to WTRU2 with the broadcast SSID and a publishing range.

In some embodiments, at step 5 of FIG. 6, WTRU2 receives the Wi-Fi broadcast request and configures its local interfaces to begin broadcast of the SSIDs.

In some embodiments, at step 6 of FIG. 6, WTRU2 sends a Wi-Fi broadcast response to the SES with an OK if it has successfully begun the broadcasting.

In some embodiments, at step 7 of FIG. 6, the SES further sends a Wi-Fi device discovery request to WTRU1 (e.g., similar to step 6 of Section FIG. 5A). Along with the parameters described above, SES may include the SSIDs that the SES would like the WTRU to discover (e.g., configured in step 3 of FIG. 6).

In some embodiments, at step 8 of FIG. 6, WTRU1 begins the discovery of Wi-Fi APs/STAs in its vicinity (e.g., similar to step 7 of FIG. 5A). WTRU1 may filter out the SSIDs that it received as part of step 7 of FIG. 6 and may generate a list of suitable Wi-Fi STAs (e.g., WTRUs).

In some embodiments, at step 9 of FIG. 6, WTRU1 sends a Wi-Fi device discovery response to the SES (e.g., similar to step 8 of FIG. 5A).

The SES on performing this discovery may factor this information in making decisions about the configurations for the Wi-Fi sensing task (e.g., step 12 of FIG. 5B).

In some embodiments, the WTRU is responsible for making decisions about the Wi-Fi sensing task. The WTRU may request the SES to enable other WTRUs to begin broadcasting a particular Wi-Fi SSID that it can discover and configure those WTRUs to perform sensing for themselves.

In some embodiments, after discovering each other, the SES requests two or more WTRUs to be initiators of different Wi-Fi sensing tasks. This may be useful if, for example, different WTRUs have different processing capabilities and perform different types of processing on similar information, or if they can provide different degrees of freedom.

In accordance with some embodiments of this disclosure, methods and systems for determining a trustworthy database of Wi-Fi Aps is provided as follows.

Wi-Fi APs and STAs that can assist wireless cellular network in Wi-Fi sensing tasks may be malicious (e.g., providing bad data purposely) or have a bad implementation (e.g., generating erroneous data) must be excluded from sensing tasks as it may not provide meaningful sensing data.

The wireless cellular network (e.g., SES) may coordinate several WTRUs with Wi-Fi sensing capabilities and over time it may build a list of trustworthy Wi-Fi APs and STAs. This list may consist of a unique identifier (e.g., a MAC address), the locations in which the APs were detected, any other identifier it can use to uniquely identify an AP/STA to a location, or any combination thereof. The SES may configure the WTRUs (e.g., when it asks them to process information in step 19 of FIG. 5B), to generate statistical information about the data the WTRU is receiving from the APs (e.g., accuracy, jitter, latency). WTRUs may then report this information as part of the metadata information it reports to the SES. The SES based on this received information, and similar information from other WTRUs or past sensing tasks (e.g., Wi-Fi or wireless cellular network) may make judgements about the trustworthiness (e.g., usability, quality, resilience, reliability) of the information received from Wi-Fi APs or Wi-Fi STAs. Over time, the wireless cellular network may use this information to build a trustworthy list of Wi-Fi Aps and/or STAs and when choosing which Aps and/or STAs to use for Wi-Fi sensing task, may leverage this information.

In accordance with some embodiments of this disclosure, examples of Wi-Fi sensing specific API. Northbound Wi-Fi sensing APIs may be available in Wi-Fi APs and STAs. A possible implementation of Wi-Fi APIs can be any one or more of the following.

A possible implementation of Wi-Fi APIs may be a Wi-Fi status API. The Wi-Fi status API may allow the application to get the current Wi-Fi status and an additional configuration to discover a list of connected STAs.

A possible implementation of Wi-Fi APIs may be a Wi-Fi sensing discovery API. The Wi-Fi sensing discovery API may allow the application to set the Wi-Fi chip to a discovery mode to find a list of SSIDs that can perform Wi-Fi sensing. The Wi-Fi sensing discovery API may have a parameter that allows applications to get the relative locations and received signal strength of the Wi-Fi sensing entities.

A possible implementation of Wi-Fi APIs may be a Wi-Fi configuration API. The Wi-Fi configuration API may allow the application to configure the Wi-Fi chip with the Wi-Fi sensing parameters (e.g., neighbor discovery protocol (NDP) frames, SBP mode, enabled capabilities). This may allow the sensing capabilities frame parameters to be setup.

A possible implementation of Wi-Fi APIs may be a Wi-Fi control API. The Wi-Fi control API may allow the application to turn on or off, switch sensing modes for Wi-Fi sensing tasks, or any combination thereof. The Wi-Fi control API may be used to accept, reject or terminate a sensing task, choose sensing responders and other parameters of the Wi-Fi sensing tasks.

A possible implementation of Wi-Fi APIs may be a Wi-Fi notification API. The Wi-Fi notification API may allow the Wi-Fi chip to notify the host operating system about any received Wi-Fi sensing frames (e.g., association, probe request, sensing measurement request, sensing measurement termination, SBP request). The Wi-Fi notification API may allow the host operating system to be informed about the sensing data measurements available messages. The notification may consist of the MAC addresses (e.g., associated ID, unassociated ID), CSI, ToF data, their accuracy, confidence interval, timing information, or any combination thereof.

In accordance with some embodiments of this disclosure, example generalizations to other non-cellular (e.g., non-3GPP) technologies are provided as follows.

Some of the technologies that can be used to assist wireless cellular network are RF-based such as UWB, BLE, radar, or non-RF based such as LiDAR and cameras. This can be enabled by similar procedures defined in this paper by extending it in the following manner.

In FIG. 3, when WTRUs register their capabilities with the SES, they may add information about other non-cellular sensors that are available on the WTRU that can be used for sensing tasks. Additionally, when the SES registers with the SCF, it may inform about other non-cellular technologies that WTRUs have registered with so SCF is aware of the additional capabilities it can use for sensing tasks.

In FIG. 5, several procedures may be updated to include non-cellular information throughout. In the sensing assistance request that the SCF sends to the SES, it can already down select the sensors it estimates will be useful for its sensing task. The SES, when requesting WTRUs to inform about its Wi-Fi status or discovery of Wi-Fi APs/STAs, may request WTRUs to discover other nearby non-cellular radios (e.g., UWB, BLE), possibly along with Wi-Fi. The SES may then choose the most appropriate non-cellular technology based on the sensing service assistance request. Similar to how Wi-Fi information is fed into the wireless cellular network, non-cellular (e.g., non-3GPP) information may follow a similar flow. If there is a need to retrieve any relevant authentication keys, the SES may communicate with other 3rd party AFs that can provide it such information. The information may also be available to the SES by means of service level agreements (SLAs) and databases that SES may have access to.

In FIG. 6, when the SES configures the two WTRUs to broadcast and discover each other, the SES may do a similar configuration for other non-cellular technologies. For example, the SES may ask one WTRU to broadcast a particular message on UWB or BLE and other WTRU to discover the same message. This may also be extended to camera or LiDAR where one WTRU can broadcast a particular pattern that may be captured on the other WTRU and used to identify if either of the WTRUs are able to discover each other and may be part of a sensing task.

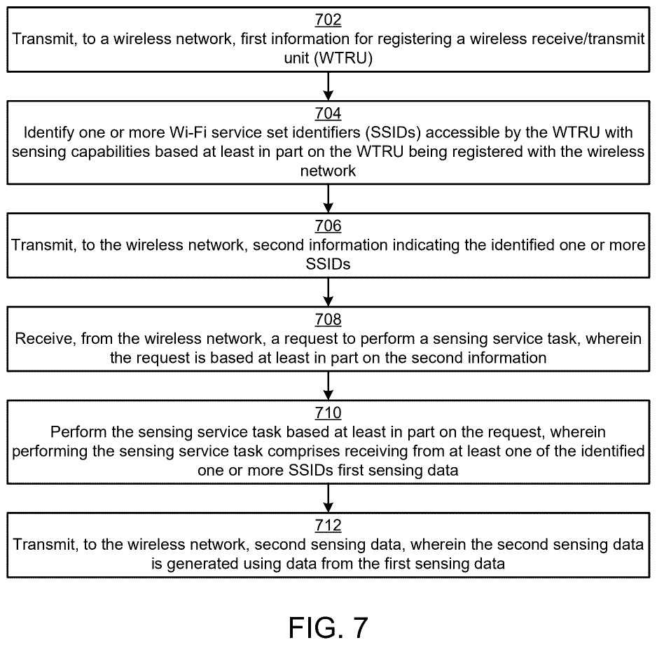

FIG. 7 is an illustrative flow diagram of steps for coordination and collection of Wi-Fi sensing data for wireless cellular networks (e.g., 6GC), according to some embodiments of this disclosure.

In some embodiments, at step 702, the WTRU transmits, to a wireless network, first information for registering the WTRU. In some embodiments, the first information comprises any one or more of a Wi-Fi connection status, information about a supported Wi-Fi sensor, a Wi-Fi performance indicator, or an identification of a connected Wi-Fi station.

In some embodiments, at step 704, the WTRU identifies one or more Wi-Fi SSIDs accessible by the WTRU with sensing capabilities based at least in part on the WTRU being registered with the wireless network.

In some embodiments, at step 706, the WTRU transmits, to the wireless network, second information indicating the identified one or more SSIDs. In some embodiments, the second information comprises any one or more of a list of Wi-Fi access points, a Wi-Fi station security parameter, a Wi-Fi station received signal strength indicator, a Wi-Fi station supported mode, or a relative distance of Wi-Fi access points.

In some embodiments, at step 708, the WTRU receives, from the wireless network, a request to perform a sensing service task, wherein the request is based at least in part on the second information. In some embodiments, the request to perform a sensing service task comprises any one or more of a sensing task ID, a consent token, a sensing object identifier, a reporting configuration, a data path, a time to perform the sensing service task, a sensing mode and its configurations, processing functions, or a reporting endpoint. In some embodiments, the request to perform the sensing service task is based on an identification of at least one key performance indicator (KPI) violation or on receiving a sensing service request.

In some embodiments, at step 710, the WTRU performs the sensing service task based at least in part on the request, wherein performing the sensing service task comprises receiving from at least one of the identified one or more SSIDs first sensing data. In some embodiments, the first sensing data indicates any one or more of a received sensing signal, sensing task ID, channel state information (e.g., processed channel state information, unprocessed channel state information), a time of flight information, an accuracy of the sensing data, micro-doppler information, an object characteristic (e.g., type, distance, velocity, trajectory, size, shape, material, quantity), a received signal strength, a relative real-time location of a Wi-Fi access point, a relative real-time location of a Wi-Fi station, or a confidence interval. In some embodiments, receiving from the at least one of the identified one or more SSIDs the first sensing data is done at a first time, performing the sensing service task comprises receiving from the at least one of the identified one or more SSIDs third sensing data at a second time, and the second time is subsequent to the first time.

In some embodiments, at step 712, the WTRU transmits, to the wireless network, second sensing data, wherein the second sensing data is generated using data from the first sensing data. In some embodiments, the WTRU transmits, to the wireless network, fourth sensing data, wherein the fourth sensing data is generated using data from the third sensing data, wherein a difference between the second time and the first time is greater than a predetermined threshold time difference. In some embodiments, the fourth sensing data comprises a rejection message of the sensing service task, wherein the rejection message of the sensing service task comprises a list of rejection reasons.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless receive/transmit unit (WTRU), the method comprising:
transmitting, to a wireless network, first information for registering the WTRU;
identifying one or more Wi-Fi service set identifiers (SSIDs) accessible by the WTRU with sensing capabilities based at least in part on the WTRU being registered with the wireless network;
transmitting, to the wireless network, second information indicating the identified one or more SSIDs;
receiving, from the wireless network, a request to perform a sensing service task, wherein the request is based at least in part on the second information;
performing the sensing service task based at least in part on the request, wherein performing the sensing service task comprises receiving from at least one of the identified one or more SSIDs first sensing data; and
transmitting, to the wireless network, second sensing data, wherein the second sensing data is generated using data from the first sensing data.

2. The method of claim 1, wherein the first information comprises any one or more of a Wi-Fi connection status, information about a supported Wi-Fi sensor, a Wi-Fi performance indicator, or an identification of a connected Wi-Fi station.

3. The method of claim 1, wherein the second information comprises any one or more of a list of Wi-Fi access points, a Wi-Fi station security parameter, a Wi-Fi station received signal strength indicator, a Wi-Fi station supported mode, or a relative distance of Wi-Fi access points.

4. The method of claim 1, wherein the request to perform a sensing service task comprises any one or more of a sensing task ID, a consent token, a sensing object identifier, a reporting configuration, a data path, a time to perform the sensing service task, a sensing mode and its configurations, processing functions, or a reporting endpoint.

5. The method of claim 1, wherein the first sensing data indicates any one or more of a received sensing signal, sensing task ID, channel state information, a time of flight information, an accuracy of the sensing data, micro-doppler information, an object characteristic, a received signal strength, a relative real-time location of a Wi-Fi access point, a relative real-time location of a Wi-Fi station, or a confidence interval.

6. The method of claim 1, wherein:
receiving from the at least one of the identified one or more SSIDs the first sensing data is done at a first time,
performing the sensing service task comprises receiving from the at least one of the identified one or more SSIDs third sensing data at a second time, and
the second time is subsequent to the first time.

7. The method of claim 6, further comprising:
transmitting, to the wireless network, fourth sensing data, wherein the fourth sensing data is generated using data from the third sensing data, wherein a difference between the second time and the first time is greater than a predetermined threshold time difference.

8. The method of claim 7, wherein the fourth sensing data comprises a rejection message of the sensing service task, wherein the rejection message of the sensing service task comprises a list of rejection reasons.

9. The method of claim 6, wherein a determination of the second time is based on at least one event, wherein the at least one event comprises any one or more of a change in a Wi-Fi connection status, a change in a Wi-Fi performance indicator, or receiving, from the wireless cellular network, a second request to perform a second sensing service task.

10. The method of claim 1, wherein the request to perform the sensing service task is based on an identification of at least one key performance indicator (KPI) violation or on receiving a sensing service request.

11. A wireless receive/transmit unit (WTRU) that is in communication with a wireless network, the WTRU comprising a processor and a transceiver, wherein the WTRU is configured to:
transmit, to a wireless network, first information for registering the WTRU;
identify one or more Wi-Fi service set identifiers (SSIDs) accessible by the WTRU with sensing capabilities based at least in part on the WTRU being registered with the wireless network;
transmit, to the wireless network, second information indicating the identified one or more SSIDs;
receive, from the wireless network, a request to perform a sensing service task, wherein the request is based at least in part on the second information;
perform the sensing service task based at least in part on the request, wherein performing the sensing service task comprises receiving from at least one of the identified one or more SSIDs first sensing data; and
transmit, to the wireless network, second sensing data, wherein the second sensing data is generated using data from the first sensing data.

12. The WTRU of claim 11, wherein the first information comprises any one or more of a Wi-Fi connection status, information about a supported Wi-Fi sensor, a Wi-Fi performance indicator, or an identification of a connected Wi-Fi station.

13. The WTRU of claim 11, wherein the second information comprises any one or more of a list of Wi-Fi access points, a Wi-Fi station security parameter, a Wi-Fi station received signal strength indicator, a Wi-Fi station supported mode, or a relative distance of Wi-Fi access points.

14. The WTRU of claim 11, wherein the request to perform a sensing service task comprises any one or more of a sensing task ID, a consent token, a sensing object identifier, a reporting configuration, a data path, a time to perform the sensing service task, a sensing mode and its configurations, processing functions, or a reporting endpoint.

15. The WTRU of claim 11, wherein the first sensing data indicates any one or more of a received sensing signal, sensing task ID, channel state information, a time of flight information, an accuracy of the sensing data, micro-doppler information, an object characteristic, a received signal strength, a relative real-time location of a Wi-Fi access point, a relative real-time location of a Wi-Fi station, or a confidence interval.

16. The WTRU of claim 11, wherein:
receiving from the at least one of the identified one or more SSIDs the first sensing data is done at a first time,
performing the sensing service task comprises receiving from the at least one of the identified one or more SSIDs third sensing data at a second time, and
the second time is subsequent to the first time.

17. The WTRU of claim 16, further configured to:
transmit, to the wireless network, fourth sensing data, wherein the fourth sensing data is generated using data from the third sensing data, wherein a difference between the second time and the first time is greater than a predetermined threshold time difference.

18. The WTRU of claim 17, wherein the fourth sensing data comprises a rejection message of the sensing service task, wherein the rejection message of the sensing service task comprises a list of rejection reasons.

19. The WTRU of claim 16, wherein a determination of the second time is based on at least one event, wherein the at least one event comprises any one or more of a change in a Wi-Fi connection status, a change in a Wi-Fi performance indicator, or receiving, from the wireless cellular network, a second request to perform a second sensing service task.

20. The WTRU of claim 11, wherein the request to perform the sensing service task is based on an identification of at least one key performance indicator (KPI) violation or on receiving a sensing service request.
